(19) United States
(12) Patent Application Publication
(10) Pub. No.: US 2007/0065610 A1
(43) Pub. Date: Mar. 22, 2007

(54) Non-foil mono-web film liner for composite container, and composite container incorporating same

(75) Inventor: Srinivas Nomula, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/231,515

(22) Filed: Sep. 21, 2005

(51) Int. Cl. B32B 27/10

(52) U.S. Cl. 428/34.2

(57) ABSTRACT

A non-foil mono-web liner for adhering to an inner surface of a paperboard body of a composite container, the liner comprising a polymer film web having an inner surface for facing an interior of the container and an outer surface for facing the paperboard body, a vapor-deposited coating of barrier material covering the outer surface of the polymer film web, a protective coating of polymer material covering the vapor-deposited coating of barrier material, and an inner heat seal layer covering the inner surface of the polymer film web and forming an innermost surface of the liner. The liner thus is structured and arranged so that when wrapped into a tubular shape with opposite edges of the liner overlapping each other, the edges are heat-sealable together via the inner heat seal layer.

### BACKGROUND OF THE INVENTION

The present invention relates to composite containers having impervious liners.

Composite containers comprise wound paperboard container bodies lined by an impervious liner that provides a barrier against the passage of oxygen and/or moisture. In some applications, the liner must provide a high degree of barrier performance, which conventionally has been achieved by using metal foil-based liners. Typical foil-based liners are laminated structures such as {paper/foil/sealant}, or {sealant/foil/sealant}. Because it is a relatively costly component of the liner, it would be desirable to eliminate the metal foil layer, while still achieving high levels of barrier performance.

### BRIEF SUMMARY OF THE INVENTION

The present invention addresses the above needs and achieves other advantages by providing a composite container and a non-foil liner therefor, wherein the non-foil liner comprises a mono-web structure. By “mono-web” is meant that the liner includes only a single web of material that is pre-manufactured and supplied in the form of a roll of the material. This is in contrast to the prior-art liners described above, wherein, for example, a paper web and a metal foil web are both pre-manufactured and supplied in roll form, and are drawn from their respective rolls and laminated together during the liner manufacturing process. In a mono-web manufacturing process, a single web is drawn from a supply roll and the web is then processed to apply various layers to the web via processes such as vapor deposition and/or extrusion coating.

In accordance with one embodiment of the invention, a non-foil mono-web liner is provided for adhering to an inner surface of a paperboard body of a composite container, the liner comprising a polymer film web having an inner surface for facing an interior of the container and an outer surface for facing the paperboard body, a vapor-deposited coating of barrier material covering the outer surface of the polymer film web, a protective coating of polymer material covering the vapor-deposited coating of barrier material, and an inner heat seal layer covering the inner surface of the polymer film web and forming an innermost surface of the liner. The liner thus is structured and arranged so that when wrapped into a tubular shape with opposite edges of the liner overlapping each other, the edges are heat-sealable together via the inner heat seal layer.

In another embodiment, the liner further comprises an outer heat seal coating covering the protective coating of polymer material and forming an outermost surface of the liner, whereby the opposite edges of the liner are lap-sealable wherein the outer heat seal coating on one edge is heat-sealed to the inner heat seal layer on the other edge.

Advantageously, the liner further comprises a coating of a polymer material applied to the outer surface of the polymer film web prior to application of the vapor-deposited coating of barrier material for enhancing effectiveness of the vapor-deposited coating of barrier material. The polymer material can be selected from the group consisting of acrylate, polyvinyl alcohol, and ethylene vinyl alcohol.

The protective coating for the barrier material layer can be selected from the group consisting of nitrocellulose lacquer, acrylic lacquer, and vacuum acrylate.

The vapor-deposited coating of barrier material can comprise a metal in substantially pure non-oxide form (e.g., aluminum), a metal oxide (e.g., aluminum oxide), or a silicon oxide.

When particularly high barrier performance is required, the liner can comprise a second vapor-deposited coating of barrier material covering the protective coating, and a second protective coating of polymer material covering the second vapor-deposited coating of barrier material.

The invention also provides a composite container having a non-foil mono-web liner as described above.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an exploded perspective view of a container in accordance with one embodiment of the invention;

FIG. 2 is a cross-sectional view through the container body, along line 2-2 in FIG. 1;

FIG. 3 is a cross-sectional view, on an enlarged scale, showing a liner in accordance with one embodiment of the invention;

FIG. 4 is a view similar to FIG. 3, showing another embodiment of the invention;

FIG. 5 is a cross-sectional view of yet another embodiment of the invention; and

FIG. 6 is a cross-sectional view of still another embodiment of the invention.

### DETAILED DESCRIPTION OF THE INVENTION

The present inventions now will be described more fully hereinafter with reference to the accompanying drawings, in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

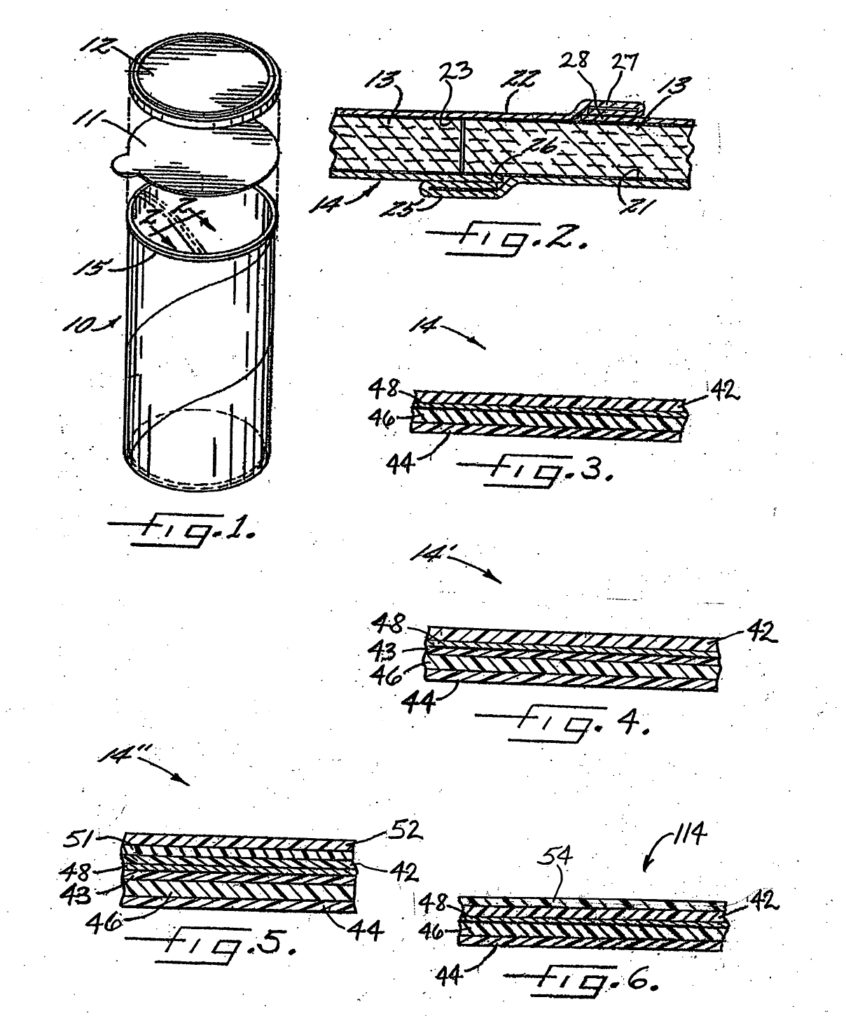

With reference to FIGS. 1 and 2, there is shown a composite container 10 having a non-foil-based liner in accordance with one embodiment of the present invention. Although illustrated as having a circular cross-section, the tubular container 10 may have any cross-sectional shape that can be formed by wrapping the composite materials around an appropriately shaped mandrel. For example, the tube can be formed in a rectangular shape with rounded comers by convolutely wrapping the materials around a suitably shaped mandrel. The embodiment illustrated in FIG. 1 is particularly advantageous for packaging potato crisps or chips and includes a flexible membrane lid 11 and a reusable plastic end cap 12 over the membrane lid. Various other end closures may be used, however, depending upon the type of product that is to be packaged. For example, where dough is to be packaged, the end caps are typically constructed of metal and are crimp-sealed onto the ends of the container.

The tubular container 10 includes a wall having one or more body plies 13 (FIG. 2) preferably formed of paperboard and a liner ply 14 adhered to the inner surface of the body ply or plies 13. The upper end of the tubular container 10 is rolled over so as to form a bead 15 or flange and the membrane lid 11 is hermetically sealed to the top of the bead. The end cap 12 is then snapped over the bead 15 and may be reused after the membrane lid 11 has been removed. A metal closure (not illustrated) can be secured to the opposite end of the container 10. Alternative closure systems can be used at the container ends. For instance, the top closure can employ a metal ring in conjunction with a membrane lid sealed to the ring.

The seams where the various plies are joined together are illustrated in FIG. 2. In some types of containers such as self-opening containers (e.g., for refrigerated dough), a single body ply is used and the edges of the ply are first skived and then joined together during the tube-forming process with an adhesive to create a strong seam. In other types of containers, a single or multiple body plies may be used and the edges of the ply or plies are not skived and form a butt joint as shown in FIG. 2, or form an overlap joint. In any event, the liner ply 14 is adhered to the inner surface of the body ply or plies 13 with a wet adhesive 21 and the overlapping edges of the liner ply are sealed together to ensure that the container 10 is completely sealed. A label ply 22 is adhered to the outer surface of the body ply 13 with an adhesive 23, and can have various graphics and/or indicia printed thereon regarding the product within the container.

The liner ply 14 includes a seal formed by overlapping a first edge portion 25 of the liner with an opposite second edge portion 26 of the liner and sealing the overlapping edge portions together. Likewise, the label 22 includes a seal formed by overlapping a first edge portion 27 with an opposite second edge portion 28 of the label and sealing the edge portions together. The liner and label are both shown in FIG. 2 with fold seals, but alternatively, the liner and/or label can be seamed with a simple lap seal if their structures permit lap seals.

A liner structure in accordance with a first embodiment of the invention is schematically depicted in FIG. 3. The liner 14 is free of any metal foil layers. The liner comprises a mono-web structure, as that term was previously defined. Thus, a single web 46 that is pre-manufactured is employed in the liner. The web 46 comprises a polymer film. The web 46 can comprise various polymers, including but not limited to polyethylene, polypropylene, polyester such as polyethylene terephthalate, nylon, and the like. To an outer surface of the web 46 is applied a layer of barrier material 48. The layer 48 is vacuum- or vapor-deposited on the outer surface of the web 46 (i.e., the surface that faces the paperboard body plies 13 of the container, see FIG. 2), which serves as the substrate for the barrier layer. In one embodiment, the layer 48 comprises a substantially pure metal in non-oxide form. Various metals can be used, but aluminum is most commonly employed. Alternatively, the layer 48 can comprise a metal oxide such as aluminum oxide, or a silicon oxide. Processes for vapor-depositing metals or oxides on polymer film are well known and are not further described herein.

A coating 42 of a protective polymer material is applied to the barrier layer 48 to protect it. The polymer material can be selected from the group consisting of nitrocellulose lacquer, acrylic lacquer, and vacuum acrylate.

The liner also includes a sealant layer 44 disposed on an inner surface of the web 46. The sealant layer 44 comprises a heat seal material. Various heat seal materials may be used, including but not limited to ionomer resins (e.g., SURLYN®, an ethylene acid copolymer with acid groups partially neutralized with zinc or sodium ions), high-density polyethylene (HDPE), low-density polyethylene (LDPE), coextruded film structures (e.g., ionomer/HDPE coex, LDPE/HDPE coex, etc.). The particular sealant material is not of importance to the present invention.

The liner 14 shown in FIG. 3 has a heat seal material 44 on only one surface of the liner. Accordingly, to form a liner seal, a fold seal is necessary, as shown in FIG. 2. More particularly, one edge of the liner is folded over to place the sealant layer 44 on the folded edge portion in contact with the sealant layer 44 on an opposite unfolded edge of the liner, and the overlapping edges are heat-sealed together. Preferably an adhesive (not shown) is applied by a suitable applicator between the folded edge portion and the surface of the liner upon which the folded edge portion is folded, so as to ensure that the edge portion does not unfold during the spiral winding process.

An alternative liner 14′ in accordance with the invention is shown in FIG. 4. The liner 14′ has a single polymer film web 46 and a sealant layer 44 disposed on the web's inner surface as in the previous embodiment. However, prior to vapor deposition, the outer surface of the web 46 is coated with a coating 43 of a material for enhancing the uniformity of vapor deposition of the barrier material 48. The coating 43 can comprise a polymer selected from the group consisting of acrylate, polyvinyl alcohol, and ethylene vinyl alcohol. As an alternative to the use of the coating 43, the outer surface of the web 46 can be treated by plasma discharge or the like, for enhancing the uniformity of vapor deposition.

Yet another embodiment of the invention is shown in FIG. 5. The liner 14″ has a single polymer film web 46 and a sealant layer 44 disposed on the web's inner surface, a vapor-deposition-enhancing coating 43 on the web's outer surface, a vapor-deposited barrier layer 48 applied to the coating 43, and a protective coating 42 applied over the vapor-deposited layer 48, as in the liner of FIG. 4. In addition, a second vapor-deposited coating 51 of barrier material is applied over the protective coating 42, and a second protective coating 52 of polymer material is applied over the second vapor-deposited coating 51 of barrier material. This liner structure is particularly useful when relatively high levels of barrier performance are needed.

The above-described liner structures have a sealant layer 44 on only one surface of the liner. FIG. 6 depicts a liner 114 generally corresponding to that of FIG. 3, but having a second sealant layer 54 covering the protective coating 42 and forming the outermost surface of the liner. The liner 114 is advantageous in that it can be lap-sealed as opposed to fold-sealed. The liners of FIGS. 4 and 5 likewise can include such a second sealant layer to make them lap-sealable, if desired.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A composite container, comprising:
a tubular container body comprising paperboard wrapped about an axis into a tubular shape; and
a non-foil mono-web liner adhered to an inner surface of the paperboard, the liner comprising a polymer film web having an inner surface facing an interior of the container body and an outer surface facing the paperboard, a vapor-deposited coating of barrier material covering the outer surface of the polymer film web, a protective coating of polymer material covering the vapor-deposited coating of barrier material, and an inner heat seal layer covering the inner surface of the polymer film web and forming an innermost surface of the liner, the liner having opposite edges that are overlapped and sealed together via the inner heat seal layer.

2. The composite container of claim 1, wherein the liner further comprises an outer heat seal coating covering the protective coating of polymer material and forming an outermost surface of the liner, the opposite edges of the liner forming a lap seal with the outer heat seal coating on one edge sealed to the inner heat seal layer on the other edge.

3. The composite container of claim 1, wherein the opposite edges of the liner form a fold seal formed by folding one edge such that the inner heat seal layer on said one edge contacts and is sealed to the inner heat seal layer on the other edge.

4. The composite container of claim 1, wherein the liner further comprises a coating of a polymer material applied to the outer surface of the polymer film web prior to application of the vapor-deposited coating of barrier material for enhancing effectiveness of the vapor-deposited coating of barrier material.

5. The composite container of claim 4, wherein the coating of polymer material for enhancing effectiveness of the vapor-deposited coating of barrier material comprises a polymer selected from the group consisting of acrylate, polyvinyl alcohol, and ethylene vinyl alcohol.

6. The composite container of claim 1, wherein the outer surface of the polymer film web is plasma-treated prior to application of the vapor-deposited coating of barrier material for enhancing effectiveness of the vapor-deposited coating of barrier material.

7. The composite container of claim 1, wherein the protective coating comprises a polymer selected from the group consisting of nitrocellulose lacquer, acrylic lacquer, and vacuum acrylate.

8. The composite container of claim 1, wherein the vapor-deposited coating of barrier material comprises a metal in substantially pure non-oxide form.

9. The composite container of claim 1, wherein the vapor-deposited coating of barrier material comprises a metal oxide.

10. The composite container of claim 1, wherein the vapor-deposited coating of barrier material comprises a silicon oxide.

11. The composite container of claim 1, wherein the liner further comprises a second vapor-deposited coating of barrier material covering the protective coating, and a second protective coating of polymer material covering the second vapor-deposited coating of barrier material.

12. A non-foil mono-web liner for adhering to an inner surface of a paperboard body of a composite container, the liner comprising a polymer film web having an inner surface for facing an interior of the container and an outer surface for facing the paperboard body, a vapor-deposited coating of barrier material covering the outer surface of the polymer film web, a protective coating of polymer material covering the vapor-deposited coating of barrier material, and an inner heat seal layer covering the inner surface of the polymer film web and forming an innermost surface of the liner, the liner being structured and arranged so that when wrapped into a tubular shape with opposite edges of the liner overlapping each other, said edges are heat-sealable together via the inner heat seal layer.

13. The non-foil mono-web liner of claim 12, wherein the liner further comprises an outer heat seal coating covering the protective coating of polymer material and forming an outermost surface of the liner, whereby the opposite edges of the liner are lap-sealable wherein the outer heat seal coating on one edge is heat-sealed to the inner heat seal layer on the other edge.

14. The non-foil mono-web liner of claim 12, wherein the liner further comprises a coating of a polymer material applied to the outer surface of the polymer film web prior to application of the vapor-deposited coating of barrier material for enhancing effectiveness of the vapor-deposited coating of barrier material.

15. The non-foil mono-web liner of claim 14, wherein the coating of polymer material for enhancing effectiveness of the vapor-deposited coating of barrier material comprises a polymer selected from the group consisting of acrylate, polyvinyl alcohol, and ethylene vinyl alcohol.

16. The non-foil mono-web liner of claim 12, wherein the outer surface of the polymer film web is plasma-treated prior to application of the vapor-deposited coating of barrier material for enhancing effectiveness of the vapor-deposited coating of barrier material.

17. The non-foil mono-web liner of claim 12, wherein the protective coating comprises a polymer selected from the group consisting of nitrocellulose lacquer, acrylic lacquer, and vacuum acrylate.

18. The non-foil mono-web liner of claim 12, wherein the vapor-deposited coating of barrier material comprises a metal in substantially pure non-oxide form.

19. The non-foil mono-web liner of claim 12, wherein the vapor-deposited coating of barrier material comprises a metal oxide.

20. The non-foil mono-web liner of claim 12, wherein the vapor-deposited coating of barrier material comprises a silicon oxide.

21. The non-foil mono-web liner of claim 12, wherein the liner further comprises a second vapor-deposited coating of barrier material covering the protective coating, and a second protective coating of polymer material covering the second vapor-deposited coating of barrier material.
